(19) United States
(12) Patent Application Publication
(10) Pub. No.: US 2012/0170085 A1
(43) Pub. Date: Jul. 5, 2012

(54) Media Sheet Holder for a Vertically Oriented Scanner

(76) Inventors: Brian Dale Cook, Nicholasville, KY (US); Timothy David Koch, Santa Clara, CA (US)

(21) Appl. No.: 12/981,210

(22) Filed: Dec. 29, 2010

(51) Int. Cl. H04N 1/04

(52) U.S. Cl. 358/498

(57) ABSTRACT

A media holder for holding a media sheet against the imaging window of a substantially vertically oriented scanning device. The media holder includes a frame having a first frame section and a second frame section, the first frame section having a first end mounted along an upper edge of the imaging window, and the second frame section extending from a second end of the first frame section at an angle with respect to the first frame section such that a media sheet slot is formed between the imaging window and the second frame section. The media holder further includes a fibrous layer adhesively attached to the frame, wherein the second frame section engages a media sheet inserted in the media sheet slot with frictional force to hold the inserted media sheet against the imaging window.

### BACKGROUND

1. Field of the Invention

The present invention generally relates to imaging devices and, more particularly, to imaging devices that perform multi-item scanning during a single scanning operation.

2. Description of the Related Art

An imaging device, for example, a scanner, is typically used in a traditional mode where a lid of the imaging device is opened and a document, having images therein, is placed on a scan glass of the imaging device. The images of the document facing the scan glass are imaged/scanned by a scanning unit disposed within the imaging device. The scanned images may be printed on a print media as desired by a user or transmitted to an external device or host.

Image scanners are used to optically scan and convert images, such as photos, text, or the like into digital images. Examples of image scanners are flatbed scanners and vertical scanners, where documents are placed on a glass, imaging window for scanning In both scanner types, media sheets to be scanned are placed face-down on the glass beneath a cover and a light source and one or more sensor arrays capture substantially the entire area of the glass imaging window. In a flatbed scanner, sheets of media can be placed simultaneously on the glass window relying on gravity to hold the media sheets in place. The entire scan area is thus made available to the user. In a vertical scanner having a substantially vertically oriented glass imaging window, however, sheets of media typically sit on a ledge along the bottom edge of the window.

When scanning multiple smaller sized sheets of media, such as photographs, simultaneously, it is difficult to make use of the upper portion of the scanned area since the smaller media occupy the lower portion thereof. This precludes a user from using more of the available scan window in a single scan operation. A variety of mechanisms exist for holding objects against a substantially vertical surface. X-ray film grips, for example, provide film engagements for holding x-ray films firmly in place against a back-lighted viewing screen. In a similar manner, some holding devices provide channels or pockets with complex mechanisms that physically capture a portion of the object to hold it in place. Most of these mechanisms are bulky structures which protrude relatively far from the perimeter of the surface to form a rigid structure to brace and clamp the objects. However, these devices are subject to a number of disadvantages, including the fact that they are difficult and expensive to assemble. Also, some of these devices exert excessive forces that can possibly permanently mark or damage the held object. Based upon the foregoing, there is a need for an improved media holder which is simple in construction and inexpensive to manufacture.

### SUMMARY OF THE INVENTION

Embodiments of the present disclosure overcome shortcomings associated with existing holding mechanisms and thereby satisfy a significant need for a media holder for a vertically originated scanning device which is unobtrusive, possesses a low-profile, and effectively holds media in place against an upper portion of the scan area of the scanning device. According to example embodiments, there is shown a media holder that conveniently is allows simultaneous scanning of multiple smaller sized originals without tearing, bending, or leaving impression marks on the media.

In an example embodiment, an image scanning device includes a substantially vertical imaging window; and a media holder for holding a media sheet against the imaging window. The media holder includes a frame having a first frame section and a second frame section, the first frame section having a first end mounted along an upper edge of the imaging window, and the second frame section extending from a second end of the first frame section at an angle with respect to the first frame section such that a media sheet slot is formed between the imaging window and the second frame section. The media holder further includes a fibrous layer adhesively attached to the frame, wherein the second frame section engages a media sheet inserted in the media sheet slot with frictional force to hold the inserted media sheet against the imaging window.

### BRIEF DESCRIPTION OF THE DRAWINGS

The above-mentioned and other features and advantages of the various embodiments of the invention, and the manner of attaining them, will become more apparent will be better understood by reference to the accompanying drawings, wherein:

FIG. 1 is a perspective view of one embodiment of a vertically oriented imaging device including an example embodiment of the present disclosure;

FIG. 2 shows a perspective view of the imaging device of FIG. 1 with a scan lid in the open position showing sheets of relatively small media suspended from a media holder according to an example embodiment;

FIG. 3 shows a cross sectional view of the imaging device of FIGS. 1 and 2 taken along the 3-3 line of FIG. 2; and

FIG. 4 is a block diagram depicting components of the imaging device of FIG.

### DETAILED DESCRIPTION

Reference will now be made in detail to the exemplary embodiment(s) of the invention, as illustrated in the accompanying drawings. Whenever possible, the same reference numerals will be used throughout the drawings to refer to the same or like parts.

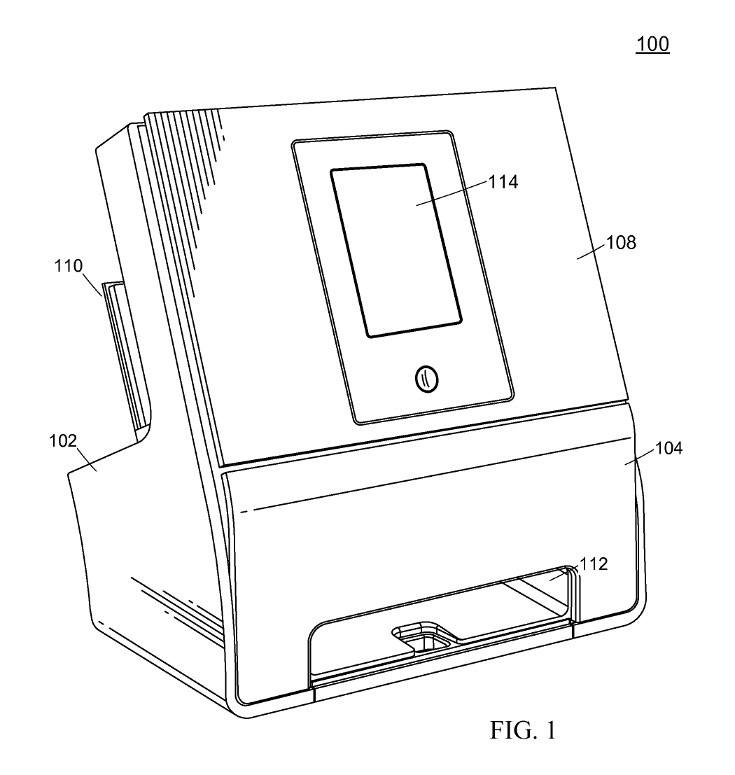

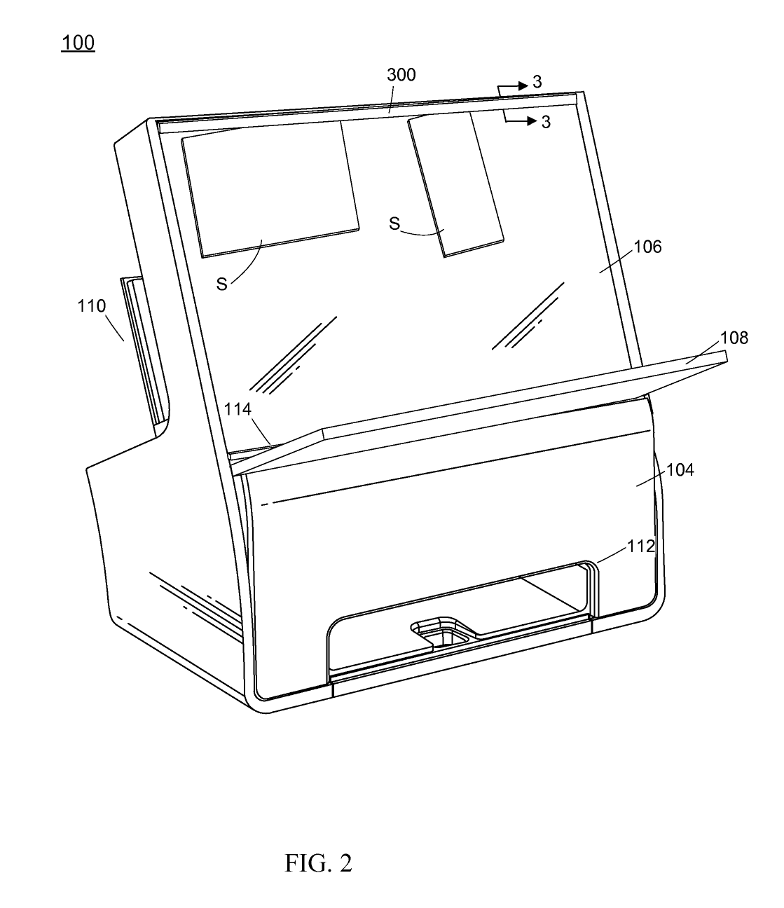

FIGS. 1 and 2 illustrate perspective views of an embodiment of an imaging is device 100 according to an exemplary embodiment. Imaging device 100, which may be a standalone imaging device, includes a housing 102 having a front portion 104 including an imaging window 106 (FIG. 2). Imaging window 106 may be constructed from a rigid, transparent and/or translucent material, such as glass.

Further, the imaging device 100 includes a lid 108 pivotally connected to the front portion 104 of the housing 102. The lid 114 may be pivotably connected along a bottom edge thereof to housing 102 via hinges or the like (not shown) to allow the lid 114 to move between a closed position as shown in FIG. 1 and an open position as shown in FIG. 2. The back portion of the imaging device 100 may have an input media tray 110 that may retain one or more print media sheets therein. A media output area 112 may be positioned along a lower part of front portion 104.

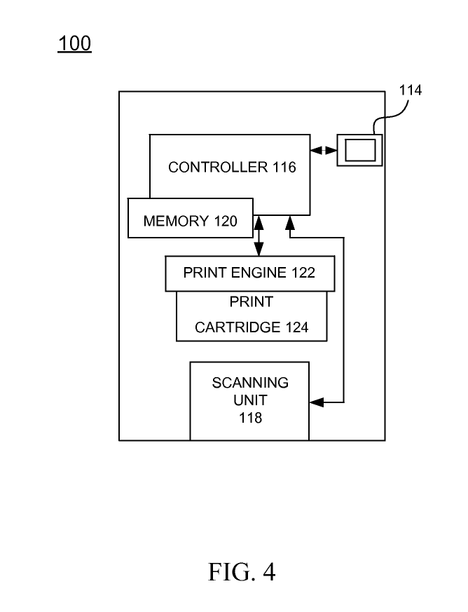

FIG. 4 is a block diagram depicting at least some of the main components of imaging device 100. Imaging device 100 may include a scanning unit 118 disposed within housing 102 which captures an image from one or more documents disposed against imaging window 106. Scanning unit 118 may be coupled to and controlled by a controller 116 of imaging device 100.

Imaging device 100 may include a print engine 122, controlled by controller 116, for printing an image onto a sheet of media. Print engine 122 may include any of a variety of different types of printing mechanisms including dye-sublimation, dot-matrix, ink-jet or laser printing. For ease of description, print engine 112 may be an inkjet printing device although such description should not be considered limiting. Print engine 122 may include a carriage (not shown) for holding at least one print cartridge 124. According to the exemplary embodiment, two print cartridges 124 may be utilized wherein, by way of example, a color cartridge is utilized for color printing and a black cartridge for text or other monochrome printing. As one skilled in the art will recognize, the color cartridge may include three inks, i.e., cyan, magenta and yellow inks. As an alternative, a single black cartridge may be used.

In another alternative embodiment, one or more printheads (not shown) may be disposed in the movable carriage and one or more stationary ink containers may be in fluid communication with the one or more printheads. In yet another alternative embodiment, at is least one stationary printhead assembly is disposed substantially entirely across the media path of imaging device 100 and at least one ink container may be in fluid communication with the printhead assembly, for providing page-wide printing.

Imaging device 100 may include one or more mechanisms (not shown) for picking a sheet of media from input media tray 110, moving the picked sheet to be adjacent print engine 122 for printing an image thereon, and moving the picked sheet having the printed image to output area 112. During advancement, the picked media sheet moves from the input media tray 110 to the media output area 112 along a substantially L-shaped media path.

Imaging device 100 may include a user interface, such as a graphical user interface, for receiving user input concerning printing operations performed or to be performed by imaging device 100, and for providing to the user information concerning same. The user interface may include firmware maintained in memory 120 within housing 102 which is performed by controller 116 or other processing element. In an example embodiment, the graphical user interface may include a display panel 114, which may be a touch screen display in which user input is provided by the user touching or otherwise making contact with panel 114. As shown in FIG. 1, display panel 114 may be disposed along the outer surface of lid 108 and sized for providing graphic images that allow for convenient communication of information between imaging device 100 and the user. Display panel 114 may include a liquid crystal display, a light emitting diode display or the like.

FIG. 2 illustrates a perspective view of the imaging device 100 with lid 108 disposed in the open position and imaging window 106 exposed. With lid 108 being in the open position, one or more sheets S of media may be disposed against imaging window 106 so that the images may be captured by a scan operation. Imaging window 106 is disposed in an inclined position at an acute angle relative to the horizontal. In one embodiment, imaging window 106 may be inclined at an angle between about 65 and about 71 degrees to the horizontal. Front portion 104 of housing 102 may also include a ledge 114 against which a sheet of media to be scanned may rest when positioned against imaging window 106.

Scanning unit 118 may include a reciprocating scan bar (not shown) and scan-related components disposed within the housing 102. The reciprocating scan bar and the scan related components are disposed adjacent to the inner surface of imaging window 106 and are in imaging relationship thereto. Further, the scan bar may reciprocate laterally in side-to-side is directions with respect to the imaging window 106 to perform a scanning operation on one or more sheets S of media positioned against imaging window 106. During an imaging operation, the scan bar may capture images of media sheets S and store the captured images in a memory of a controller 116 or other processor of imaging device 100.

Alternatively, instead of utilizing a scan bar for capturing an image of one or more media sheets S a few scan lines at a time, scanning unit 118 may capture substantially the entire image of the media sheets S at one time. By capturing an entire image substantially simultaneously, the scan bar and its corresponding drive mechanism are not utilized. In this alternative embodiment, imaging device 100 may include light sources of sufficient number and placement to generate and direct light towards the one or more media sheets S disposed against imaging window 106 so that light reflections may be captured by one or more image sensors within housing 102 (not shown).

According to an example embodiment, imaging device 100 may include a media holding mechanism 300 for supporting one or more sheets S of media against imaging window 106. Media holding mechanism 300 may be disposed along the upper portion of imaging window 106 so that sheets S of media may be suspended therefrom. In this way, a majority surface of imaging window 106 may be available for capturing images from multiple sheets S of media in a single image capture operation.

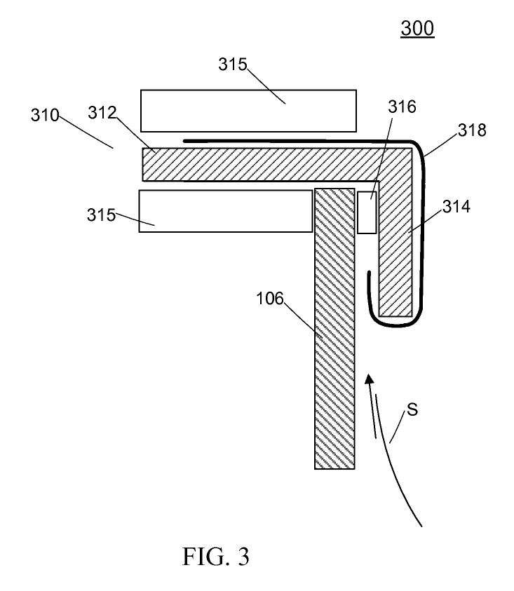

Referring to FIG. 3, media holding mechanism 300 may include a frame member 310 disposed along the upper edge of imaging window 106. Frame member 310 may include a first frame section 312 and second frame section 314 which in one example embodiment may form a substantially L-shaped cross section. Alternatively, first frame section 312 and second frame section 314 may be positioned at an acute angle relative to each other. Frame member 310 may be formed from a material such as plastic. First frame member 312 and second frame member 314 serve to bias a sheet S of media against imaging window 106 when a portion of the sheet S is inserted between imaging window 106 and second frame section 314. In an example embodiment, a cross-sectional length of first frame section 312 may be between about 0.25 inches and about 0.5 inches, and a length of second frame section 314 may be between about 0.12 inches and about 0.25 inches.

An end of first frame section 312 may be disposed within housing 102 and particularly between cover members 315 of housing 102 in a substantially fixed position. Second frame section 314 extends from the outwardly extending end of first frame section 312 and is positioned adjacent the upper, outer surface of imaging window 106 at a distance therefrom so as to form a slot. Second frame section 314 is sized so that second frame section 312 extends sufficiently in front of the upper, outer surface of imaging window 106 by an amount to temporarily secure a media sheet S in the slot between second frame section 314 and imaging window 106 when inserted therein. The slot may be sized to accommodate media sheets up to about 0.5 mm thick.

As shown in FIG. 3, media holding mechanism 300 may further include a stopper member 316 disposed between second frame section 314 and the upper, outer surface of imaging window 106 so as to limit the amount of insertion of a media sheet S between second frame section 314 and imaging window 106. Alternatively, media holding mechanism 300 does not include a stopper member 316 in which case a portion of first frame section 312 may be used to limit the amount of media sheet insertion.

Media holding mechanism 300 may include a sheet of material 318 disposed about a portion of frame member 310 and which serves to substantially prevent a media sheet S from slipping out of a desired position when a portion of sheet S is inserted between imaging window 106 and second frame section 314. Material 318 may be wrapped around and secured to frame member 310 using an adhesive (not shown). In one embodiment, material 318 may be secured to at least a portion of the upper surface of first frame section 312 and the outer surface, bottom surface and a portion of the inner surface of second frame section 314, as shown FIG. 3. By securing material 318 to frame member 310 in this way, material 318 will be substantially less likely to be inadvertently moved over time from the insertion of media sheets S within the gap between imaging window 106 and second frame section 314.

According to an example embodiment, the sheet of material 318 may be flock paper having relatively short or crushed fibers secured to the sheet to form a textured surface, such as a velvet like surface. The fibers may be any of a number of different compositions, including wool or cotton. It is understood, however, that the sheet of material 318 may be constructed from other material.

As described above, the scanning unit 118 of imaging device 100 captures an image appearing on at least one sheet S of media that is disposed against imaging window 106 during a scan operation. In an example embodiment, the extent of the image captured corresponds to substantially the entire area of imaging window 106, including the area of imaging window 106 disposed adjacent and/or behind second frame section 314. In this embodiment, controller 116 or other processor of imaging device 100 may receive the image captured during a scan operation and determine whether the portion of the captured image corresponding to the area of imaging window 106 behind second frame section 314 includes image content. This determination may, for example, include detecting a pixel value in the captured image corresponding to such area which is different from a pixel value when no sheet is inserted between imaging window 106 and second frame section 314, or detecting varying pixel values in the captured image corresponding to such area. Upon a determination that the portion of the image corresponding to the area of imaging window 106 behind second frame section 314 fails to include any content, then the captured image is cropped to remove such image portion. Otherwise, if content is detected, then the captured image is not cropped. In this way, the resulting image better matches the intended image captured.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. An image scanning device, comprising:
a substantially vertical image scanning window; and
a media holder for holding a media sheet against the image scanning window, the media holder comprising:
a frame having a first frame section and a second frame section, the first frame section having a first end mounted along an upper edge of the image scanning window, the second frame section extending from a second end of the first frame section at an angle with respect to the first frame section such that a media sheet slot is formed between the image scanning window and the second frame section; and
a fibrous layer adhesively attached to the frame;
wherein the second frame section engages a media sheet inserted in the media sheet slot with frictional force to hold the inserted media sheet against the scanning window.

2. The image scanning device of claim 1, further comprising a controller configured to:
acquire a scanned image of the media sheet in the media scanning window;
detect whether or not image content is present in a portion of the scanned image corresponding to an area of the media sheet that is inserted into the media sheet slot between the second frame section and the scanning window; and
remove the portion from the scanned image in response to a negative determination.

3. The image scanning device of claim 1, wherein the media holder further comprises a stopper disposed in an upper portion of the media sheet slot between the scanning window and the second frame section to limit an insertion amount of the media sheet inserted in the media sheet slot.

4. The image scanning device of claim 1, wherein the fibrous layer comprises flock paper.

5. The image scanning device of claim 1, wherein the media sheet slot accommodates media sheets up to about 0.5 mm thick.

6. The image scanning device of claim 1, wherein the frame comprises a plastic material.

7. The image scanning device of claim 1, wherein the first frame section and the second frame section form a substantially L-shape.

8. The image scanning device of claim 1, wherein an acute angle is formed between the first frame section and the second frame section.

9. The image scanning device of claim 1, wherein the second frame section includes an outer surface, an inner surface within the media sheet slot and an intermediate surface disposed between the outer surface and the inner surface, and the fibrous layer is positioned adjacent more than one of the outer surface, the inner surface and the intermediate surface.

10. The image scanning device of claim 8, wherein the fibrous layer is positioned along the outer, inner and intermediate surfaces of the second frame section.

11. The image scanning device of claim 1, wherein the fibrous layer is disposed adjacent a surface of the first frame section and an outer surface and an inner surface of the second frame section, the inner surface of the second frame section being within the media sheet slot.

12. A media sheet holder for a substantially vertical image-scanning device, comprising:
an elongated frame having a first portion and a second portion, the first portion being attached along an upper edge of a scan glass panel of the vertical image-scanning device, the first and second portions for biasing an edge portion of a media sheet against the scan glass panel, the first portion having a upper surface and a lower surface, the second portion having an inner surface and an outer surface; and
a media sheet contact layer attached to at least the inner surface of the second portion, to provide a surface-to-surface contact with the edge portion of the media sheet.

13. The media sheet holder of claim 12, further comprising a media edge stopper insertably disposed between the inner surface of the second portion and the scan glass panel of the vertical image-scanning device, to limit an extent of insertion of the edge portion of the media sheet between the inner surface of the second portion and the scan glass panel.

14. The media sheet holder of claim 12, wherein the media sheet contact layer is a fibrous medium adhesively attached to at least the inner surface of the second portion.

15. The media sheet holder of claim 12, wherein the media sheet contact layer wraps around the second portion from the inner surface to the outer surface.

16. The media sheet holder of claim 12, wherein the media sheet contact layer is disposed against the inner and outer surfaces of the second portion and the upper surface of the first portion.

17. The media sheet holder of claim 12, wherein the first and second portions are substantially L-shaped in cross section.

18. The media sheet holder of claim 12, wherein the media sheet contact layer comprises flock paper.
